(19) United States
(12) Patent Application Publication
(10) Pub. No.: US 2023/0389128 A1
(43) Pub. Date: Nov. 30, 2023

(54) COMMUNICATIONS DEVICE, INFRASTRUCTURE EQUIPMENT AND METHODS

(71) Applicant: Sony Group Corporation, Tokyo (JP)

(72) Inventors: Vivek SHARMA, Basingstoke (GB); Yuxin WEI, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/028,249

(22) PCT Filed: Oct. 1, 2021
(86) PCT No.: PCT/EP2021/077132

§ 371 Date: Mar. 24, 2023

(30) Foreign Application Priority Data
Oct. 5, 2020 (EP) 20200162.4

(51) Int. Cl. H04W 76/40; H04W 76/19

(52) U.S. Cl. CPC H04W 76/40; H04W 76/19

(57) ABSTRACT

A method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface, measuring, in the first RRC mode, a radio link quality associated with the wireless access interface, determining, based on the radio link quality, that predetermined criteria are satisfied, the predetermined criteria for continuing to receive the data associated with the service in the first RRC mode in the cell, and after determining that the predetermined criteria are satisfied, receiving further data associated with the service.

### BACKGROUND

### Field

The present disclosure relates to communications devices, infrastructure equipment and methods for the transmission of multicast or broadcast data in a wireless communications network.

The present application claims the Paris Convention priority from European patent application number EP20200162.4, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems Hi, as well as future iterations/releases of existing systems, to efficiently support connectivity for a wide range of devices associated with different applications and different characteristic data traffic profiles.

Although most conventional services are provided by means of unicast data transmissions, many services may be more suited to the use of multicast or broadcast transmission. The provision of such services gives rise to new challenges for efficiently handling communications in wireless telecommunications systems that need to be addressed.

### SUMMARY

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 illustrates a process for a communications device detecting a radio link failure in accordance with conventional techniques;

FIG. 5 is a combined message sequence chart and process diagram for receiving multicast/broadcast service (MBS) data after a radio link failure in accordance with embodiments of the present technique;

FIG. 6 is a combined message sequence chart and process diagram for receiving multicast/broadcast service (MBS) data after a radio link failure in accordance with embodiments of the present technique;

FIG. 7 is a combined message sequence chart and process diagram for receiving MBS data in accordance with embodiments of the present technique; and

FIG. 8 is a process flow diagram for a process which may be carried out by a communications device in accordance with embodiments of the present technique.

### DETAILED DESCRIPTION OF THE EMBODIMENTS

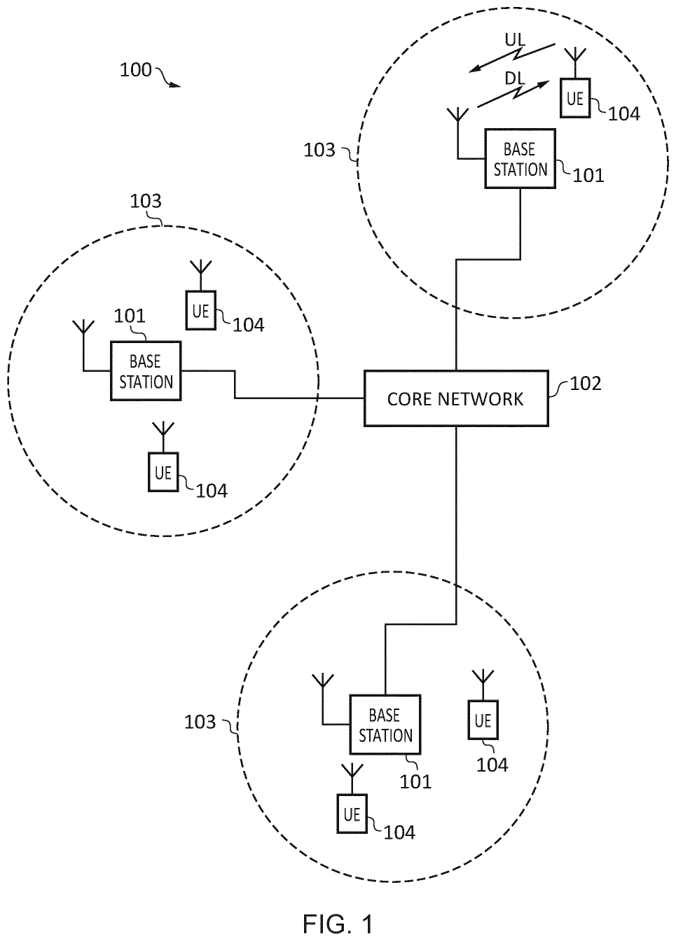

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

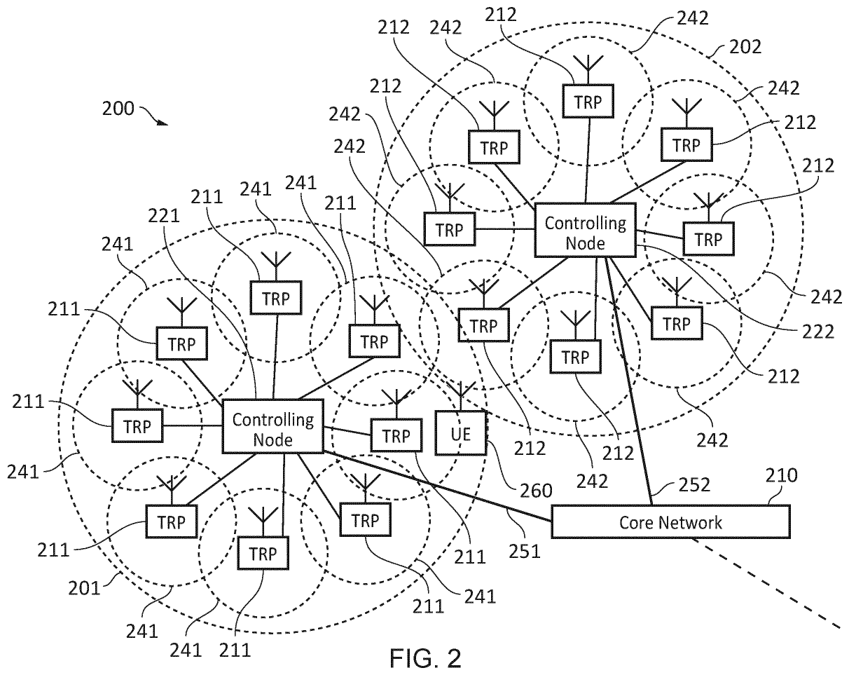

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

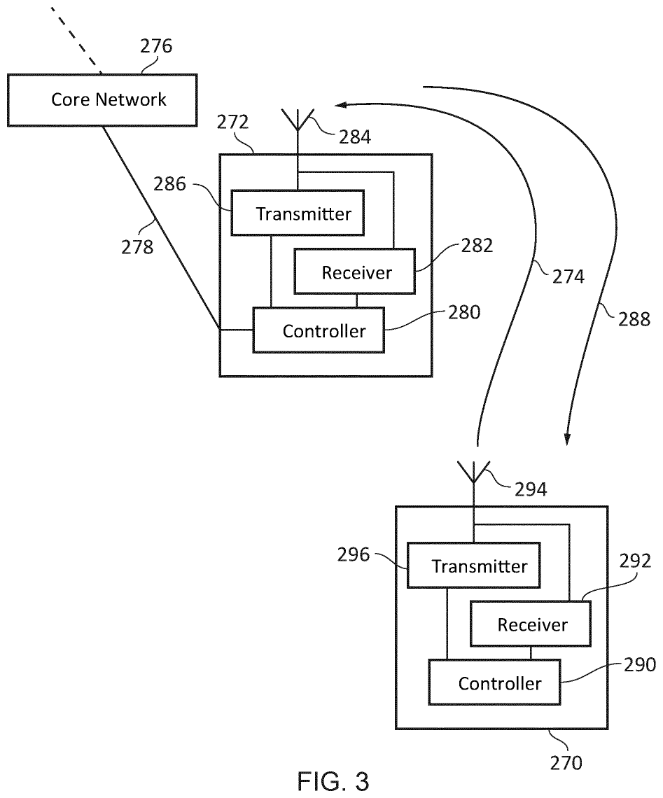

A more detailed illustration of a communications device 270 and an example network infrastructure equipment 272, which may be thought of as a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

Radio Bearers

A transmission between a communications device and an infrastructure equipment may be associated with a radio bearer. A radio bearer may be a logical connection, which may be associated with one or more logical channels and one or more corresponding transport channels. A bi-directional radio bearer may be associated with a pair of logical channels (one each for uplink and downlink) and a pair of transport channels (one each for uplink and downlink).

For example, a data radio bearer (DRB) for the transmission of user plane data may be associated with two dedicated traffic channels (DTCH) for the transmission of uplink and downlink user data, respectively, associated with a single communications device. One of the DTCHs may in turn be associated with a downlink (DL) shared channel (DL-SCH), and the other may be associated with an uplink (UL) shared channel (UL-SCH).

Conventionally, there may be provided signalling radio bearers (SRBs) for the transmission of signalling messages between the communications device 270 and the infrastructure equipment 272. In particular, the following SRBs may be defined [7]:
SRB0 for RRC messages using a common control channel (CCCH) logical channel;
SRB1 for RRC messages (which may include a piggybacked NAS message) as well as for NAS messages prior to the establishment of SRB2, all using a dedicated control channel (DCCH) logical channel;
SRB2 for NAS messages, all using DCCH logical channel. SRB2 has a lower-priority than SRB1 and is always configured by the network after security activation.

An RRC Connected mode may correspond to a mode in which the communications device has an established RRC connection with the infrastructure equipment. Data may be transmitted to or from the communications device, for example by means of granted resources on a shared channel. While in the RRC Connected mode, a change of serving cell of the communications device may be under the control of the network, and may be effected by, for example, a handover.

An RRC Idle mode may correspond to a mode in which no RRC connection is established. A communications device may conventionally transition from the RRC Idle mode to the RRC Connected mode by means of, for example, a random access procedure leading to the establishment of an RRC connection. While in the RRC Idle mode, a change of serving cell of the communications device may carried out autonomously by the communications device such as by means of a cell reselection procedure.

Radio Link Failure and Connection Re-Establishment

A radio link quality associated with a serving cell (such as the cell 103) may be assessed periodically, such as once in each predefined time duration. The cell's radio link quality may be determined based on measurements of signals transmitted on predetermined resources, which may be associated with an activated bandwidth part (BWP). Predetermined thresholds may be used, together with the assessed radio link quality, to determine whether a radio link failure cell has occurred in respect of a cell.

RRC Re-establishment may be triggered by a communications device such as the communications device 270, in response to a determination of a radio link failure (RLF) when it is in RRC Connected mode and has an RRC connection for which security has been activated. The radio link failure may be determined to have occurred (in other words, determined to have been detected) if radio link measurements for the infrastructure equipment 272 satisfy one or more pre-determined radio link failure criteria.

In response to a determination that a radio link failure has occurred while a communications device is in RRC Connected mode, a communications device may conventionally attempt to re-establish a connection only if, at the time of the radio link failure,
at least one data radio bearer (DRB) was established,
a signalling radio bearer for the transmission of non-access stratum (NAS) messages, such as an SRB2 bearer, was established, and
access stratum (AS) security was activated. [3]

If one or more of these conditions is not satisfied, then re-establishment is not carried out and the communications device enters an RRC Idle mode.

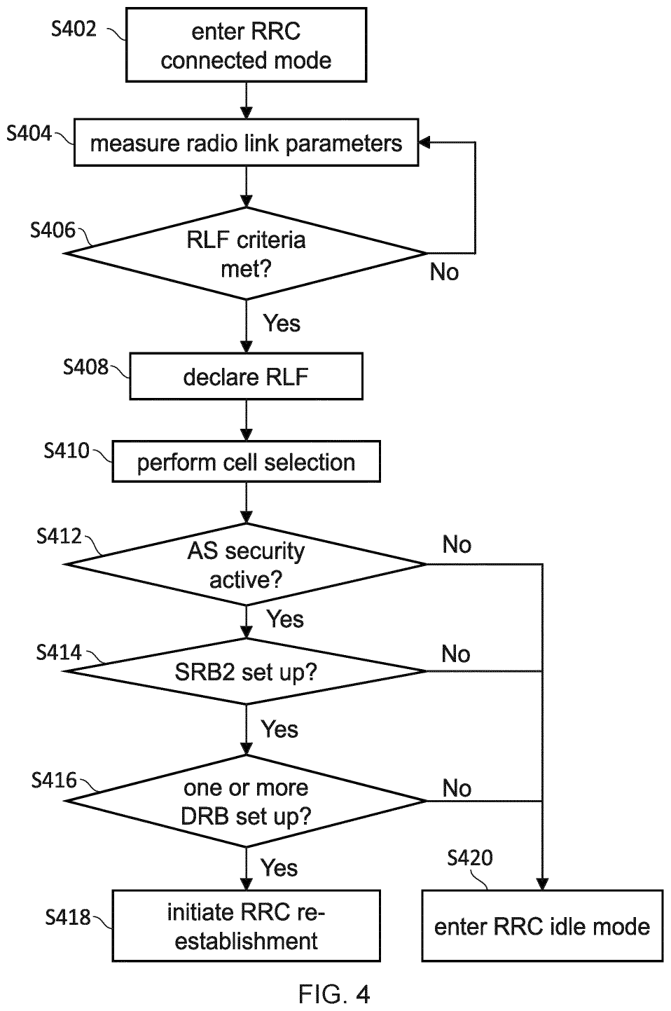

FIG. 4 illustrates a process for a communications device detecting a radio link failure in accordance with conventional techniques.

The process starts at step S402, where the communications device enters the RRC connected mode in a cell. At step S404, the communications device performs radio link monitoring. As part of the radio link monitoring, measurements for determining whether radio link failure criteria are satisfied may be carried out. The measurements may comprise radio link measurements.

At step S406, the communications device determines whether the criteria for radio link failure are satisfied. These may be based on the radio link monitoring, and/or on other criteria. RLF may be determined to have occurred in response to a mobility procedure failure, integrity failure on SRB1 or SRB2, or a failure of an RRC reconfiguration procedure.

If the criteria are not satisfied (‘No’), then the process returns to step S404.

Steps S404 and S406 may be carried out periodically.

If at step S406, the criteria are satisfied, then control passes to step S408 and a radio link failure (RLF) is declared. At step S408, upper protocol layers may be notified of the RLF. At step S408, the communications device 208 may suspend all radio bearers except SRB0.

Subsequently at step S410, the communications device may perform a cell selection procedure in accordance with conventional techniques, to select a suitable cell.

At step S412, the communications device determines whether access stratum (AS) security was activated when in RRC connected mode (i.e. prior to step S408). If it was not, then control passes to step S420, and the communications device enters RRC idle mode, and the process ends.

If AS security was activated (‘Yes’ at step S412), the control passes to step S414.

At step S414, the communications device determines whether a signalling radio bearer, which may be a signalling radio bearer established exclusively for the transmission of encapsulated NAS messages, and may be an SRB2, was established prior to step S408. If not, then control passes to step S420.

If the signalling radio bearer was established (‘Yes’ at step S414), the control passes to step S416.

At step S416, the communications device determines whether one or more data radio bearers, established for the transmission of higher layer data, was established prior to step S408. If not, then control passes to step S420.

If a data radio bearer was established (‘Yes’ at step S416), the control passes to step S418.

At step S418, the communications device initiates RRC re-establishment. It may do this by initiating a random access procedure in the selected cell (which may be the cell in which RLF was determined, or a different cell), to obtain an allocation of uplink resources. The communications device may then transmit an RRC Re-establishment request message to the infrastructure equipment (e.g. gNB) of the new cell, using the allocated uplink resources on a CCCH/SRB0.

If the gNB which controls the selected cell has, or is able to obtain, a stored context for the communications device and is therefore able to verify the contents of the RRC Re-establishment request, then in response to receiving the RRC Re-establishment request message, the gNB transmits an RRC Re-establishment message providing parameters to enable the communications device to re-establish an RRC connection in the selected cell.

Following step S420, the communications device may initiate the establishment of a new RRC connection in the selected cell. This may allow the communications device to establish an RRC connection, and enter RRC Connected mode, when the serving infrastructure equipment of the selected cell does not have (or cannot access) a context for the RRC connection established prior to the radio link failure.

Multicast/Broadcast Services (MBS)

Many services provided to wireless communications devices are unicast services. With a unicast service, only a single communications device receives the service, which may be for example a voice call, a data transfer, or the use of a point-to-point messaging service.

A multicast and broadcast service (MBS) allows multiple devices to receive the same service, simultaneously. An example of a multicast service is a group voice call, in which the same voice content is received simultaneously by multiple communications devices within a particular group. An example of a broadcast service is a streaming service, such as an audio or video broadcast, which can be received and decoded, simultaneously, by all capable communications devices within a particular coverage area.

Receiving (or providing) a service in this context may comprise the use of uplink transmissions, downlink transmissions or both. The provision of an MBS may be exclusively by means of downlink transmissions, although in some examples, a communications device receiving the MBS may be required to transmit information in the uplink, for example relating to feedback and/or measurement reports.

In the present description, the terms unicast, broadcast and multicast are used in the context of a particular wireless communications network, or a portion thereof (such as a single cell). Thus, for example, when a single user in a cell accesses a streaming service from a third party server outside of the wireless communications network, this may be considered to be (for the present purposes) a unicast service, even though the third party server may permit simultaneous access to multiple devices (even within the same cell) by means of multiple respective connections which are, from the perspective of the wireless communications network, unicast connections. The terms multicast and broadcast as used herein therefore may relate to the case where it is the radio access network and/or core network of the wireless communications network which enable the reception of the service by two or more devices simultaneously. For example, the case where a core network provides multicasting functionality to allow multiple communications devices, each in different cells, to receive a single service simultaneously, falls within the scope of the present disclosure, even if the transmission to the respective communications devices in each cell is (within the scope of that cell) by means of unicast transmission.

Multicast/Broadcast services thus can efficiently provide the same service to multiple users within the wireless communications network, by using fewer communications resources (on a wireless access network and/or on internal connections within the wireless communications network) than would be required to provide the same service to multiple users by means of unicast connections.

MBS data may be transmitted using a radio bearer. A bearer used for the transmission of MBS data is referred to herein as an MBS radio bearer (MRB). A point-to-point (PTP) MRB may be a DRB or may be a type of radio bearer different from a DRB. Where the MB S data is multicast within a cell using point-to-multipoint (PTM) transmission, an MRB may be associated with a transport channel of a type for multicast transmission within a cell. In an example, the transport channel may be a multicast broadcast traffic channel (MBTCH) and the associated physical channel may be a DL-SCH.

Certain proposals for the mapping of bearers carrying MBS data to logical and physical channels are set out in [4], [5], the contents of which are incorporated by reference in their entirety.

Certain proposals (e.g. [4]) assume that common security parameters will apply to PTP and PTM bearers for a given MBS service i.e. a common set of security keys is used for both PTP and PTM bearers used for the same MBS service, different from a set of keys used for a unicast session of a UE. Other proposals (e.g. [5]) assume that MBS data when transmitted in a unicast manner, will use a conventional DRB.

According to yet a further proposal, no security is applied to transmissions via a PTM bearer, but a communications device receives MBS bearer in RRC Connected mode.

A communications device may be in an RRC mode which allows for reception of the MBS service. In particular, the communications device may receive an MBS service via an MRB while in the RRC Connected mode.

There is, however, a need to ensure that a communications device can continue to receive the MBS service, should a radio link quality deteriorate.

Embodiments of the present technique can provide a method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface, measuring, in the first RRC mode, a radio link quality associated with the wireless access interface, determining, based on the radio link quality, that predetermined criteria are satisfied, the predetermined criteria for continuing to receive the data associated with the service in the first RRC mode in the cell, and after determining that the predetermined criteria are satisfied, receiving further data associated with the service.

Embodiments of the present technique can allow a communications device to continue to receive data associated with an MBS service. In particular, where the communications device has entered an RRC mode where re-establishment is, in general, permitted (such as RRC connected mode), the communications device may perform re-establishment and after the re-establishment, continue to receive the MBS data.

A communications device may receive the MBS data in RRC Connected mode, without having an established certain types of radio bearers. For example, a communications device may receive the MBS data in RRC connected mode, when neither a DRB nor an SRB2 are established. Embodiments of the present technique can allow the communications device to perform a re-establishment in such circumstances, and thus continue to obtain the MBS service. The re-establishment may be initiated, for example, in response to a determination of a radio link failure.

Embodiments can permit the communications device to continue to receive MBS data associated with the service, with a low interruption time, even when the only service currently obtained by the communications device is the MBS service. When the only service currently obtained by the communications device is the MBS service, the communications device may not be configured with bearers and/or bandwidth parts for the transmission of data not related to the MBS service.

In some embodiments, the re-establishment may be of a radio bearer used for the transmission of the MBS data, thus minimising signalling, and reducing a delay associated with a disruption to MBS data reception.

In some embodiments of the present technique, the communications device performs re-establishment irrespective of the establishment of a DRB and/or SRB2 when in RRC connected mode. In some such embodiments, resources for a bearer for receiving the MBS data are configured as part of the re-establishment procedure. In some embodiments, resources for a bearer for receiving the MBS data are configured after the re-establishment procedure.

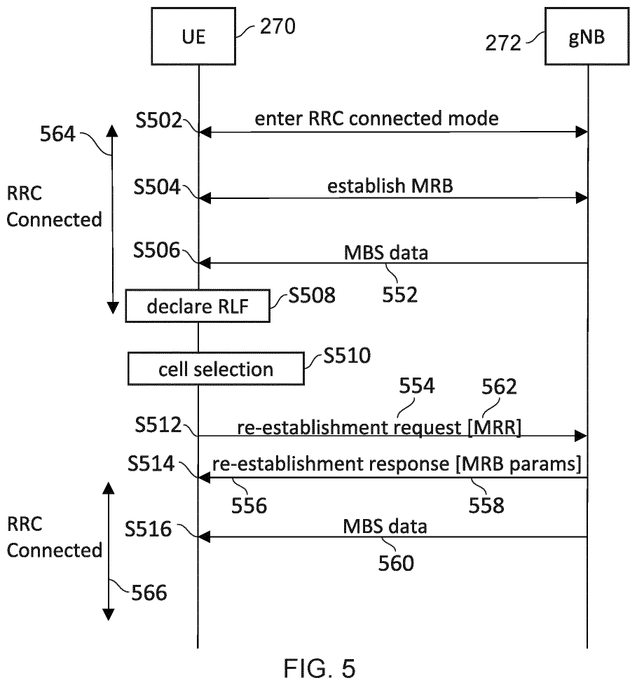

FIG. 5 shows a combined message sequence chart and process diagram for the re-establishment of a connection in accordance with embodiments of the present technique.

In FIG. 5 and similar figures, time progresses from top to bottom, but is not to scale.

At step S502, the communications device 270 enters RRC connected mode in a first cell controlled by the infrastructure equipment 272. This may comprise the establishment of an RRC connection, and the activation of AS security.

At step S504, the communications device 270 establishes a bearer (referred to herein as an MBS radio bearer, MRB) for the purposes of receiving MBS data in the cell.

In some embodiments, the MRB may be already established in the cell, and at step S504, the communications device may gain permission to receive data via the already-established MRB, and may acquire parameters (such as security parameters, communication resources, and/or transmission parameters) for receiving the MB S data via the MRB.

The MRB may be a point-to-multipoint (PTM) bearer or a point-to-point (PTP) bearer. The MRB may be associated with security parameters (such as encryptions keys or precursors thereof) which are common to one or more other MRBs. The other MRBs may be PTP or PTM MRBs and may be configured in the same cell or different cells from the cell in which the communications device 270 carries out step S504.

The MRB used prior to a radio link failure is referred to as a ‘first MRB’.

The communications device 270 may, in some embodiments, not establish one or more of a DRB and/or an SRB2 in the cell.

Subsequently, at step S506, the communications device 270 receives MBS data 552 from the infrastructure equipment 270 via the MRB.

At step S508, the communications device 270 determines that criteria for radio link failure are satisfied. In response to the determination, the communications device leaves the RRC Connected mode (as indicated by the arrow 564). At this point, the communications device 270 may be configured with one or more MRBs for the purpose of receiving MB S data. The communications device 270 may not be configured with a DRB or with SRB2, or may be configured with only one of a DRB and SRB2. The communications device 270 may be configured with SRB1 and may use SRB1 for the transmission of any NAS signalling.

Each MRB may be associated with a corresponding identifier, such as a group radio network temporary identifier (G-RNTI).

In accordance with some embodiments of the present technique, the communications device 270 determines to proceed with a re-establishment procedure. This determination may be irrespective of whether a DRB (for transmitting and receiving data not associated with the MBS service) was established in the cell when step S508 is carried out, and/or may be irrespective of whether SRB2 was established in the cell when step S508 is carried out. In some embodiments, the communications device 270 determines to proceed with a re-establishment procedure if it was configured to receive MBS data via an MRB when the radio link failure criteria are satisfied.

As described above, in the example of FIG. 5, the determination to perform re-establishment is made irrespective of the setup of any DRB or of SRB. In some embodiments, the determination may be conditional on AS security having been activated, and SRB2 and at least one DRB are setup.

At step S510, the communications device 270 performs cell selection, which may be in accordance with conventional techniques.

In some embodiments, the cell selection may comprise reading system information of a candidate cell, and selecting that cell as the new cell only if the system information comprises information for allowing the communications device 270 to receive the MBS data in the candidate cell, for example by means of a PTM bearer. The information in the candidate cell system information may comprise PTM bearer configuration information. The cell selection may be autonomous or may be network-assisted. For example, a network-assisted cell selection may comprise receiving in the current cell from the infrastructure equipment 272 an indication of a candidate cell to be selected.

In some embodiments, the cell selection may comprise selecting a cell as the new cell if a configuration valid in the current cell (i.e. the one in which the radio link failure was detected) is also valid in the cell.

In the example of FIG. 5, the communications device 270 selects, at step S510, a cell which is controlled by the infrastructure equipment 272, but it will be appreciated that the infrastructure equipment controlling the selected cell may be a different infrastructure equipment. The selected cell may be the same cell in which the MBS data 552 was received.

At step S512, the communications device 270 transmits a re-establishment request 554 to the infrastructure equipment 272. The re-establishment request 554 may comprise an MRB re-establishment request (MRR) 562 indicating that the communications device 270 is requesting the re-establishment of, or to (re)gain access to, an/the MRB used to receive the MBS data 552.

At step S514, the infrastructure equipment transmits a re-establishment response 556, in response to the re-establishment request 554. In some embodiments where the MRR 562 is transmitted as part of the re-establishment request 554, the re-establishment response 556 may comprise MRB parameters 558.

In some embodiments, the MRR 562 may be transmitted after the communications device 270 has entered RRC connected mode after the re-establishment procedure.

In some embodiments (including those where the MRR 562 is transmitted after the re-establishment), the MRB parameters 558 may be transmitted separately from the re-establishment response 556, for example after the communications device 270 has completed the re-establishment procedure and entered RRC connected mode.

The MRB parameters 558 may provide the parameters needed for the communications device 270 to receive further MBS data via an MRB (the ‘second MRB’) in the selected cell. Where the selected cell is the same as the first cell, the first MRB may be the same as the second MRB. However, the second MRB may be different from the first MRB, even if the selected cell and the first cell are the same.

The first and second MRBs may be both PTM bearers, both PTP bearers, or one PTM bearer and one PTP bearer. The first MRB and second MRB may share parameters, such as security keys and/or parameters defining resources on which the respective MBS data is transmitted.

After receiving the re-establishment response 556, the communications device 270 may enter the RRC connected mode, as indicated by the arrow 566.

At step S516, the communications device 270 receives the further MBS data 560 via the second MRB.

Accordingly, embodiments of the present technique can ensure that the communications device 270 is able to receive MBS data after radio link quality in a cell deteriorates.

In the example of FIG. 5, after the radio link failure, the communications device enters, by means of a re-establishment procedure, the RRC Connected mode, and continues to receive the MBS data 560 while in the RRC Connected mode (as indicated by the arrow 566).

In some embodiments, the MBS data 560 is received while the communications device is in an RRC idle mode, or in an RRC inactive mode. In some such embodiments, for example, the communications device may be in RRC connected mode in first cell and receiving MBS data via a first MRB (which may be a PTP or PTM bearer), and in response to determining that radio link failure occurs in the first cell, selects a second cell and receives further MBS data via a second PTM MRB in RRC mode.

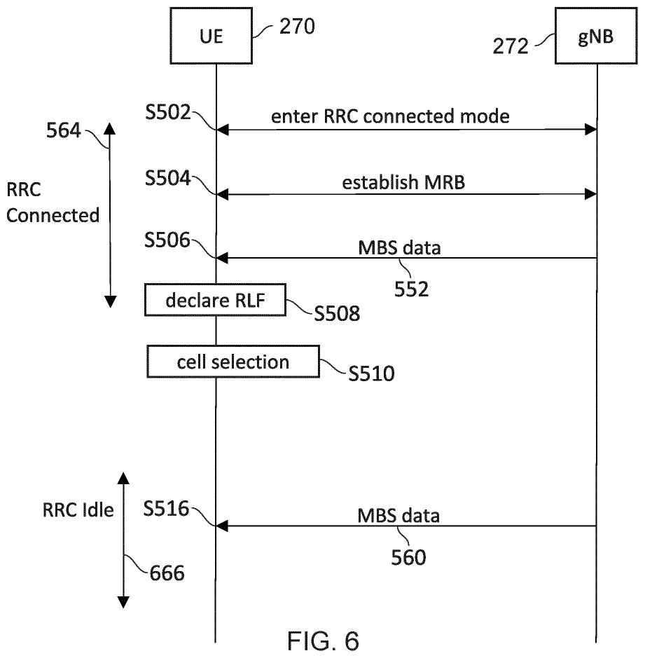

FIG. 6 shows a combined message sequence chart and process diagram for receiving MBS data after a radio link failure in accordance with embodiments of the present technique.

Many of the steps and elements shown in FIG. 6 are the same as in FIG. 5. These are numbered with like reference numerals and their description is omitted for conciseness.

Unlike the example shown in FIG. 5, in the example of FIG. 6, in response to the radio link failure detected at step S508, the communications device 270 does not initiate a re-establishment procedure.

In some embodiments, the communications device 270 may determine, in response to the radio link failure at step S508, whether or not to perform a re-establishment. In some embodiments, this may be in accordance with conventional conditions for re-establishment, specifically, that
if AS security has been activated, and
SRB2 and at least one DRB are not setup, then the communications device 270 determines to refrain from performing the re-establishment and move to RRC Idle mode, as in the example of FIG. 6.

If the conditions for re-establishment are satisfied, then the communications device 270 initiates the re-establishment, and may proceed as in the example of FIG. 5.

The communications device 270 may perform a cell selection at step S510.

The communications device 270 then remains in RRC Idle mode (as indicated by the arrow 666) and receives the MBS data 560 while in the RRC Idle mode.

The MBS data 560 may be transmitted using a PTP or PTM MRB. The MRB may be the same MRB as that used to receive the MBS data 552 while in the RRC Connected mode. Accordingly, the communications device 270 may receive the MBS data 560 by using the same parameters as used during the RRC Connected mode to receive the MBS data 552.

In some embodiments, the communications device 270 may receive, while in the RRC Connected mode and before determining that a radio link failure has occurred, an inactive mode configuration from the infrastructure equipment 272. The inactive mode configuration may comprise parameters indicating that the communications device 270 is permitted to enter an RRC Inactive mode after leaving the RRC Connected mode. In the RRC Inactive mode, no RRC connection is active between the communications device 270 and the infrastructure equipment 272, but the infrastructure equipment 272 and the communications device 270 each maintain a corresponding context allowing an RRC connection to subsequently be established, thus reducing the time required to subsequently re-enter the RRC Connected mode.

In some embodiments, the inactive mode configuration may be transmitted within an RRC Reconfiguration message.

In some embodiments, the communications device 270 may, in response to determining that radio link failure has occurred, determine, based on whether it has received an inactive mode configuration, whether to enter the RRC inactive mode or to enter the RRC idle mode.

Accordingly (or otherwise) when the communications device 270 has received an inactive mode configuration and detects a radio link failure, it may enter the RRC inactive mode and continue to receive the MBS data while in the RRC inactive mode. Such embodiments may be broadly similar to the example of FIG. 6, except that the communications device 270 receives the inactive mode configuration (not shown in FIG. 6) and the MBS data 560 is received in the RRC inactive mode, instead of in the RRC idle mode.

In some embodiments, the MBS data 552 may be received via a PTM MRB. However, should radio link failure occur and/or a re-establishment be necessary, it may not be possible to quickly re-establish a PTM MRB. On the other hand, it may be possible to re-establish a PTP MRB (for example where the PTP MRB is a DRB).

Embodiments of the present technique can provide a method wherein the communications device 270 requests the provision of the MBS service via a PTP bearer, such as a DRB, in response to determining that predetermined criteria are satisfied.

In some embodiments, when receiving MBS data via a PTM bearer, the network may receive limited, or no, feedback from the communications device regarding link quality, measurement reports, data acknowledgements and the like. Indeed, it may be the case that the communications device receives the MBS data without the infrastructure equipment associated with a current cell being aware of this (e.g. because the network does not require the communications device to perform any uplink signalling when receiving the MBS data via a PTM bearer). The infrastructure equipment may in particular not be aware that the radio conditions applicable to the MBS data being received by the communications device are deteriorating.

In some embodiments, when receiving MBS data via a PTP bearer, certain feedback is provided to the network. The nature of this feedback may depend on the RRC mode of the communications device, and/or whether the PTP bearer is a DRB or not. In any case, the network (e.g. the infrastructure equipment) may have more information associated with the communications device and its ongoing reception of MBS data when the data is received via a PTP bearer, than when it is received via a PTM bearer. Accordingly, re-establishment may be possible only when the data is received via a PTP bearer.

Embodiments of the present technique can ensure that should, subsequently, criteria associated with a radio link failure be satisfied, the communications device is able to perform a re-establishment procedure and, subsequent to the re-establishment procedure, receive the MBS data, such as via the PTP bearer.

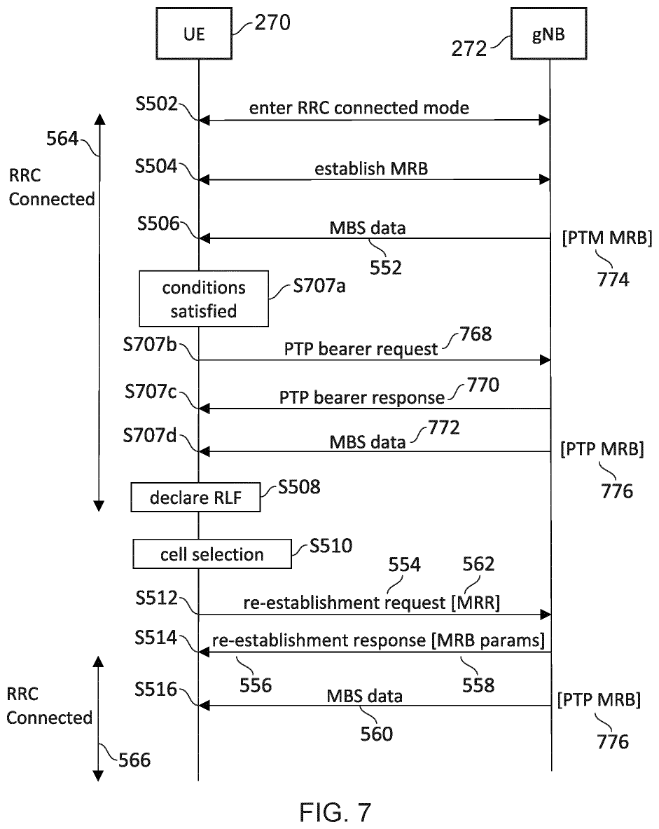

FIG. 7 shows a combined message sequence chart and process diagram for receiving MBS data after a radio link failure in accordance with embodiments of the present technique.

Many of the steps and elements shown in FIG. 7 are the same as in FIG. 5. These are numbered with like reference numerals and their description is omitted for conciseness.

In the example of FIG. 7, in accordance with some embodiments, the MBS data 552 is received at step S506 via a point-to-multipoint (PTM) bearer 774. Although such a bearer may allow multiple communications devices in a cell to receive the MBS data 552 while making efficient use of communication resources, it may be more complex and/or slower for a communications device to continue to receive further MBS data via the PTM bearer after a radio link failure.

At step S707a, the communications device 270 determines that certain predetermined conditions are satisfied. These may be based on measurements of a radio link in the cell. The measurements may be the same as, or a subset of, those used to determine whether or not a radio link failure has occurred. The predetermined conditions may be such that where a radio link is deteriorating (e.g. is resulting in a higher rate of bit or block errors, and/or is subject to increasing path loss and/or interference), the predetermined conditions will be satisfied before the conditions for radio link failure are satisfied.

At step S707b, in response to determining at step S707a that the predetermined conditions are satisfied, the communications device 270 transmits a PTP bearer request 768 to the infrastructure equipment 272. The PTP bearer request 768 indicates that the communications device 270 is requesting to receive MBS data via a point to point (PTP) bearer. The PTP bearer request 768 may comprise an indication of the identity of the MBS service (e.g. a temporary multicast/broadcast group identifier, TMGI) and/or an identity of or associated with the PTM MBR 774 by which MBS data 552 is received (for example, a radio network temporary identifier, RNTI).

At step S707c, the infrastructure equipment 272 transmits a PTP bearer response 770 to the communications device 270. The PTP bearer response 770 may comprise an indication of parameters associated with a PTP bearer 776 by which MBS data may be received. The parameters may include security parameters, transmissions parameters and/or parameters characterising communication resources to be used by the PTP bearer. The PTP bearer 776 may be a conventional DRB.

At step S707d, the infrastructure equipment 272 transmits, and the communications device 270 receives, MBS data 772 via the PTP bearer 776.

Subsequently, at step S508 the communications device 270 determines that the conditions for radio link failure are satisfied. At this point, as in example of FIG. 5, the communications device 270 may have no SRB2 established, and/or no DRB established (for example, where the PTP MRB 776 is not a DRB).

Steps S510, S512, S514 and S516 may proceed as in the example of FIG. 5. In some embodiments, for example where the PTP MRB 776 is a DRB, the MRR 562 and MRB parameters 558 may be omitted from the re-establishment request 554 and the re-establishment response 556, respectively.

The MBS data 560 received at step S516 may be transmitted via the PTP MRB 776 which has been re-established as a result of the re-establishment procedure.

In some embodiments, the MBS data 552 is received at step S506 via a point-to-point (PTP) MBS bearer, the PTP MBS bearer not being a DRB, instead of via the PTM bearer 774 as in the example of FIG. 7. A (non-DRB) PTP MBS bearer may provide certain advantages for receiving the MBS data 552 in comparison to a conventional DRB. For example, certain procedures required for the establishment and/or maintenance of a DRB may not be required where only a PTP MRB is being established and maintained. However, it may be more complex and/or slower for a communications device to continue to receive further data (such as the MBS data 560) via a PTP MBS bearer established or re-established after a radio link failure than for a conventional DRB.

In some embodiments, the PTP MRB 776 is a conventional DRB.

Accordingly, the communications device 270 is able to receive the MBS data 560 after a radio link failure.

In accordance with some embodiments, the communications device 270 performs radio link measurements and periodically evaluates the radio link failure criteria. The radio link failure criteria may be standardised and/or configured by the infrastructure equipment 272 by means of RRC configuration or re-configuration.

In some embodiments, the communications device 270 evaluates criteria which are implementation specific, that is, neither specified by a standards specification, nor configured by the network. These are referred to as implementation-specific criteria. Accordingly, steps disclosed herein, such as moving to an idle or inactive mode, performing cell selection, and/or requesting establishment or re-establishment of a bearer for receiving further MBS data may be in response to determining that the predetermined, implementation specific, criteria are satisfied.

In some embodiments, when evaluating the implementation-specific criteria, the communications device does not perform any radio link monitoring, and/or does not perform reference signal received power (RSRP) or reference signal received quality (RSRQ) measurements.

In some embodiments, the MBS data may be received via a dedicated multicast bandwidth part (BWP). If the only service the communications device 270 is receiving in the RRC connected mode is the MBS service, then the communications device 270 may be configured with only the dedicated multicast BWP.

In some embodiments, the implementation-specific criteria are evaluated if the communications device 270 is configured with only a single BWP, which is used for receiving the MBS service. In some embodiments, the implementation-specific criteria are evaluated if the communications device 270 is receiving the MBS service via PTM bearer.

In some embodiments, in response to determining that the implementation-specific criteria are satisfied, the communications device may carry out one or more steps (such as cell selection) as if a radio link failure (based on predetermined and standardised or configured criteria) is determined to have occurred. For example, steps following step S508 in FIG. 5, FIG. 6 and FIG. 7 may be taken in response to determining that the implementation specific criteria have been met.

In some embodiments, the implementation-specific criteria may be applicable to (i.e. based on) HARQ statistics and/or channel state information (CSI) measurements.

In some embodiments, the implementation-specific criteria may be based on statistics or measurements which are reported to the infrastructure equipment to provide feedback related to the provision of the MBS service via PTM transmission.

In some embodiments, the predetermined conditions evaluated at step S707a in the example of FIG. 7 may be the implementation-specific criteria.

Although referred to as implementation-specific criteria, these may be based at least in part on criteria or parameters which are standardised, configured by the network, or a combination of these. For example, where the nature of the feedback associated with a PTM bearer is configured by the network, the implementation-specific criteria may relate to parameters reported in (or used to derive) such feedback. For example, where certain acknowledgement information is requested by the network in respect of the MBS data, the implementation-specific criteria may be based on that acknowledgement information.

Accordingly, embodiments of the present technique can reduce the complexity and processing required when receiving MBS data, compared with that required when configured with a conventional DRB in RRC Connected mode. Embodiments can also provide for the evaluation of criteria based on measurements or other information which is required to be determined for providing requested feedback to the network.

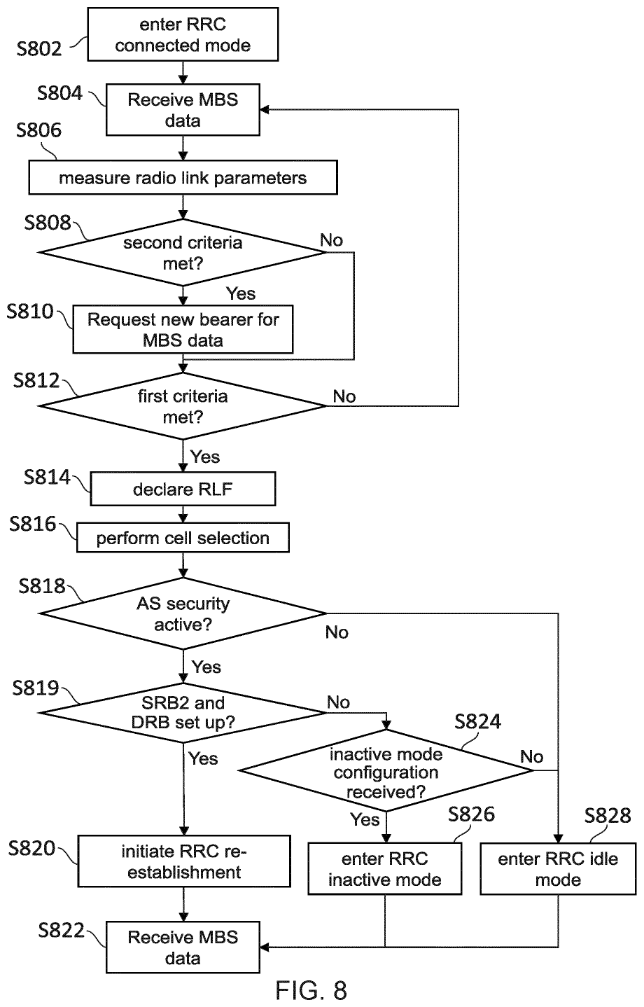

FIG. 8 is a process flow diagram for a process which may be carried out by a communications device in accordance with embodiments of the present technique. It will be appreciated that in some embodiments, steps may be added, modified, deleted and/or re-ordered.

The process of FIG. 8 starts at step S802, in which the communications device 270 enters RRC connected mode. In some embodiments, the communications device 270 may enter a different RRC mode instead, such as RRC inactive mode. Step S802 may be carried out solely in order to obtain an MBS service. Accordingly, one or more conventional steps (such as establishment of a DRB for non-MBS data transmission, and/or establishment of SRB2) may be omitted.

At step S804, the communications device 270 receives MBS data. This may be via a PTP or PTM bearer, and may be by means of communications resources of a specific BWP configured for the transmission of multicast data.

At step S806, the communications device 270 performs measurements of a radio link quality. The radio link quality may be based on one or more of a received signal strength, received signal quality, number or rate of detected errors, and the like.

At step S808, the communications device 270 may evaluate second criteria, to determine whether or not to request the transmission of the MBS data via a different type of bearer. The second criteria may be satisfied only if (or may be evaluated only if) the communications device 270 is currently receiving MBS data via a bearer which cannot be re-established by means of a re-establishment procedure.

The second criteria may be based on radio link parameters, such as those measured at step S806. The second criteria may be specified by the network and/or may be standardised. In some embodiments the communications device may receive an indication of the second criteria which is transmitted by the infrastructure equipment, for example in system information, by means of an RRC configuration message, or as part of step S802.

If the second criteria are evaluated and satisfied, then control passes to step S810, otherwise control passes to step S812.

At step S810, the communications device 270 transmits a request to receive the MB S data via a different type of bearer. For example, the communications device may request to receive the MBS data via a PTP bearer or via a DRB.

If the communications device 270 receives a response to the request, it reconfigures its receiver to receive the MBS data via the new bearer.

Control passes to step S812.

At step S812, the communications device 270 determines whether first criteria are satisfied. The first criteria may be configured or standardised and associated with radio link failure criteria and may determine whether it is possible for the communications device to continue to receive the MDS data in the current RRC mode. If these criteria are satisfied, then control passes to step S814. Otherwise, control returns to step S804.

At step S814, the communications device 270 may determine that a radio link failure has occurred. This may be in accordance with conventional radio link failure criteria, or may be based on implementation-specific criteria as described elsewhere herein, such as based on feedback measurements provided to the network. The determination may trigger other actions, in accordance with conventional techniques. For example, a notification to higher protocol layer entities within the communications device 270 may be issued.

At step S816, the communications device 270 may perform a cell selection. This may be based on conventional techniques and/or may include criteria related to the ability of the communications device 270 to receive the MBS data in a candidate cell as indicated by system information or otherwise, such that the communications device 270 may select a cell in which the MBS data can be received.

At step S818 and (if carried out, step S819), the communications device 270 may determine whether to perform re-establishment. In some embodiments, these steps may be omitted, and control may pass directly to step S820.

In the example of FIG. 8, the determination at steps S818 and S819 is in accordance with conventional criteria, whereby a positive determination is permitted only if AS security is activated (step S818, Yes), and both a DRB and an SRB2 were established for the communications device 270 at the time of the evaluation at step S812 (step S819, Yes).

If it is determined that re-establishment is to be carried out, then control passes to step S820.

At step S820, a re-establishment request is transmitted to the infrastructure equipment of the selected cell. The re-establishment request may comprise an indication of the MBS service, or an MBS bearer previously used for receiving data associated with the MBS service.

The infrastructure equipment 270 may establish, or re-establish a bearer. The bearer may be for the reception of data associated with the MBS service. If the bearer is not suitable for the reception of the MBS data, the communications device 270 may request the establishment of, or access to, such a bearer.

The process then continues with step S822 and the communications device 270 receives further data associated with the MBS service.

If, at step S818, it is determined that AS security is not activated (‘No’), then control passes to step S828, and the communications device 270 enters RRC idle mode.

If at step S819, it is determined that one or both of SRB2 and a DRB are not set up, meaning that re-establishment is not to be attempted, then control passes to step S824. At step S824, it is determined whether or not an inactive mode configuration was received by the communications device 270 prior to step S814. If it was, the control passes to step S826, and the communications device 270 enters RRC Inactive mode.

If no inactive mode configuration was received, the control passes to step S828, and the communications device 270 enters the RRC idle mode.

Subsequent to steps S826 and S828, control passes to step S822, and the communications device 270 receives further MBS data in its new RRC state.

Above have been given descriptions of example processes combining sequences of steps and messages in combination. The scope of the present disclosure is not, however, limited to such specific combinations and in some embodiments, various of the steps and messages described may be omitted, or combined in a different manner or order, or otherwise modified. Features or steps described in the context of one example may be combined with features or steps described in the context of another example.

In particular, FIG. 5, FIG. 6, FIG. 7 and FIG. 8 illustrate aspects of various embodiments within the scope of the present disclosure. These aspects may be combined other than in the specific combinations illustrated and described above. In particular, certain steps may be added, modified, deleted and/or re-ordered. The resulting combinations are examples falling within the scope of the present disclosure.

In some embodiments, the communications device may be configured to select from one or more such examples in response to an indication by the infrastructure equipment. The indication may form a part of an RRC configuration, or be transmitted in system information, for example.

For example, the infrastructure equipment may transmit an indication as to whether (and if so, under what conditions) the communications device is permitted to perform re-establishment in response to determining a radio link failure has occurred while receiving MBS data. An example of such a condition may be that the MBS data is received via a PTP MRB. Accordingly, in such an example, the communications device may determine, in response to determining that a radio link failure has occurred, whether or not the conditions are satisfied, and performing subsequent steps in accordance with the indication received from the network.

Thus there has been described a method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface, measuring, in the first RRC mode, a radio link quality associated with the wireless access interface, determining, based on the radio link quality, that predetermined criteria are satisfied, the predetermined criteria for continuing to receive the data associated with the service in the first RRC mode in the cell, and after determining that the predetermined criteria are satisfied, receiving further data associated with the service.

There has also been described a method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface via a point to multipoint (PTM) bearer, determining that second predetermined criteria are satisfied, and in response to determining that the second predetermined criteria are satisfied, transmitting a point to point (PTP) bearer request, the PTP bearer request requesting parameters for a PTP bearer for receiving the data associated with the service.

There has also been described a method of transmitting data associated with a service at an infrastructure equipment, the service being a multicast or broadcast service, the method comprising transmitting to a communications device the data associated with the service, the communications device in a first RRC mode, and receiving a re-establishment request transmitted by the communications device, wherein when the re-establishment request is received, no data radio bearer was established for the communications device or no signalling radio bearer (SRB) for the transmission of encapsulated non-access stratum (NAS) messages was established for the communications device.

There has also been described a method of transmitting data associated with a service at an infrastructure equipment, the service being a multicast or broadcast service, the method comprising establishing an RRC connection with a communications device in a cell, transmitting in the cell the data associated with the service, the data transmitted using communication resources of a wireless access interface via a point to multipoint (PTM) bearer, and receiving a point to point (PTP) bearer request transmitted by the communications device, the PTP bearer request requesting parameters for a PTP bearer for receiving the data associated with the service.

Corresponding apparatus, circuitry and computer readable media have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein.

It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches can be applied in respect of any type communications device receiving multicast or broadcast data.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface, measuring, in the first RRC mode, a radio link quality associated with the wireless access interface, determining, based on the radio link quality, that predetermined criteria are satisfied, the predetermined criteria for continuing to receive the data associated with the service in the first RRC mode in the cell, and after determining that the predetermined criteria are satisfied, receiving further data associated with the service.

2. A method according to paragraph 1, the method comprising transmitting, in response to determining that the predetermined criteria are satisfied, a re-establishment request message.

Paragraph 3. A method according to paragraph 2 or paragraph 1, wherein no data radio bearer (DRB) was established for the communications device when the predetermined criteria are satisfied.

Paragraph 4. A method according to any of paragraphs 1 to 3, wherein no signalling radio bearer (SRB) for the transmission of encapsulated non-access stratum (NAS) messages was established for the communications device when the criteria for the radio link failure were satisfied.

Paragraph 5. A method according to paragraph 4, wherein the signalling radio bearer is a signalling bearer exclusively for the transmission of uplink or downlink information messages which encapsulate NAS messages.

Paragraph 6. A method according to any of paragraphs 2 to 5, the method comprising receiving a re-establishment response message, the re-establishment response message transmitted in response to the re-establishment request message and entering the first RRC mode.

Paragraph 7. A method according to paragraph 6, wherein the re-establishment response message comprises an indication of parameters associated with a new radio bearer, and wherein receiving the further data associated with the service comprises receiving the data via the new radio bearer.

Paragraph 8. A method according to paragraph 7, wherein the new radio bearer is a point-to-multipoint bearer.

Paragraph 9. A method according to any of paragraphs 1 to 8, wherein receiving the further data associated with the service comprises receiving the data associated with the service when in the first RRC mode.

Paragraph 10. A method according to paragraph 1, the method comprising in response to determining that the predetermined criteria are satisfied, entering a second RRC mode, wherein receiving the further data associated with the service comprises receiving the further data associated with the service when in the second RRC mode.

Paragraph 11. A method according to paragraph 10, wherein the second RRC mode is an RRC idle mode.

Paragraph 12. A method according to paragraph 10, wherein the second RRC mode is an RRC inactive mode, the method comprising receiving, in the first RRC mode, an inactive mode configuration.

Paragraph 13. A method according to any of paragraphs 10 to 12, the method comprising: in response to determining that the predetermined criteria are satisfied, determining whether an inactive mode configuration was received in the first RRC mode, wherein entering the second RRC mode is in response to the determining whether an inactive mode configuration was received in the first RRC mode.

Paragraph 14. A method according to any of paragraphs 1 to 13, the method comprising in response to determining that the predetermined criteria are satisfied, performing a cell selection.

Paragraph 15. A method according to any of paragraphs 1 to 14, the method comprising in response to determining that the predetermined criteria are satisfied, determining that a radio link failure has occurred.

Paragraph 16. A method according to any of paragraphs 1 to 15, the method comprising receiving an indication of one or more of the predetermined criteria.

Paragraph 17. A method according to paragraph 16, wherein the indication of the one or more of the predetermined criteria is received within an RRC reconfiguration message.

Paragraph 18. A method according to any of paragraphs 1 to 15, wherein the predetermined criteria are implementation-specific criteria.

Paragraph 19. A method according to any of paragraphs 1 to 18, wherein in the first RRC mode, the communications device is configured with a single bandwidth part, the single bandwidth part for receiving the MBS data.

Paragraph 20. A method according to any of paragraphs 1 to 19, wherein receiving further data associated with the service comprises receiving the further data via a point to multipoint (PTM) bearer.

Paragraph 21. A method according to any of paragraphs 1 to 20, wherein the receiving the data associated with the service comprises receiving the data via a point to multipoint bearer, the method comprising before determining that the predetermined criteria are satisfied, determining that second predetermined criteria are satisfied, and in response to determining that the second predetermined criteria are satisfied, transmitting a point to point (PTP) bearer request, the PTP bearer request requesting parameters for a PTP bearer for receiving the data associated with the service.

Paragraph 22. A method according to paragraph 21, the method comprising receiving a PTP bearer response, the PTP bearer response transmitted in response to the PTP bearer request and indicating parameters associated with a PTP bearer for receiving the data associated with the service.

Paragraph 23. A method according to paragraph 21 or paragraph 22, the method comprising receiving an indication of the second predetermined criteria.

Paragraph 24. A method according to any of paragraphs 1 to 19, or paragraphs 21 to 23, wherein receiving further data associated with the service comprises receiving the further data via a point to point (PTP) bearer.

Paragraph 25. A method according to paragraph 24, wherein the PTP bearer is a data radio bearer.

Paragraph 26. A method of receiving data associated with a service at a communications device, the service being a multicast or broadcast service, the method comprising establishing an RRC connection in a cell, receiving in the cell, in a first radio resource control (RRC) mode, the data associated with the service, the data transmitted using communication resources of a wireless access interface via a point to multipoint (PTM) bearer, determining that second predetermined criteria are satisfied, and in response to determining that the second predetermined criteria are satisfied, transmitting a point to point (PTP) bearer request, the PTP bearer request requesting parameters for a PTP bearer for receiving the data associated with the service.

Paragraph 27. A method according to any of paragraphs 1 to 26, wherein the first RRC mode is an RRC connected mode.

Paragraph 28. A method of transmitting data associated with a service at an infrastructure equipment, the service being a multicast or broadcast service, the method comprising transmitting to a communications device the data associated with the service, the communications device in a first RRC mode, and receiving a re-establishment request transmitted by the communications device, wherein when the re-establishment request is received, no data radio bearer was established for the communications device or no signalling radio bearer (SRB) for the transmission of encapsulated non-access stratum (NAS) messages was established for the communications device.

Paragraph 29. A method according to paragraph 28, the method comprising transmitting a re-establishment response message, the re-establishment response message transmitted in response to the re-establishment request message.

Paragraph 30. A method according to paragraph 29, wherein the re-establishment response message comprises an indication of parameters associated with a new radio bearer, the method comprising transmitting further data associated with the service via the new radio bearer.

Paragraph 31. A method according to paragraph 30, wherein the new radio bearer is a point to multipoint bearer.

Paragraph 32. A method according to any of paragraphs 28 to 31, the method comprising transmitting an indication of one or more predetermined criteria, wherein the re-establishment request is transmitted by the communications device in response to determining that the predetermined criteria are satisfied.

Paragraph 33. A method according to any of paragraphs 28 to 32, wherein transmitting to the communications device the data associated with the service comprises transmitting the data via a point to multipoint bearer, the method comprising before receiving the re-establishment request, receiving a point to point bearer request transmitted by the communications device and requesting parameters for a PTP bearer for receiving the data associated with the service.

Paragraph 34. A method according to paragraph 33, the method comprising transmitting a PTP bearer response, the PTP bearer response transmitted in response to the PTP bearer request and indicating parameters associated with a PTP bearer for receiving the data associated with the service.

Paragraph 35. A method according to paragraph 33 or paragraph 34, the method comprising transmitting an indication of second predetermined criteria, wherein the point to point bearer request is transmitted in response to determining, by the communications device, that the second predetermined criteria are satisfied.

Paragraph 36. A method of transmitting data associated with a service at an infrastructure equipment, the service being a multicast or broadcast service, the method comprising establishing an RRC connection with a communications device in a cell, transmitting in the cell the data associated with the service, the data transmitted using communication resources of a wireless access interface via a point to multipoint (PTM) bearer, and receiving a point to point (PTP) bearer request transmitted by the communications device, the PTP bearer request requesting parameters for a PTP bearer for receiving the data associated with the service.

Paragraph 37. A communications device for operating in a wireless communications network, the communications device comprising a transmitter configured to transmit signals on a wireless access interface provided by an infrastructure equipment of the wireless communications network, a receiver configured to receive signals on the wireless access interface, the signals representing data associated with a service, the service being a multicast or broadcast service and a controller configured to control the transmitter and the receiver so that the communications device is operable to establish an RRC connection in a cell, to receive in the cell, in a first radio resource control (RRC) mode, the data associated with the service, the data transmitted using communication resources of a wireless access interface, to measure, in the first RRC mode, a radio link quality associated with the wireless access interface, to determine, based on the radio link quality, that predetermined criteria are satisfied, the predetermined criteria for continuing to receive the data associated with the service in the first RRC mode in the cell, and after determining that the predetermined criteria are satisfied, to receive further data associated with the service.

Paragraph 38. Circuitry for a communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, the signals representing data associated with a service, the service being a multicast or broadcast service and controller circuitry configured to control the transmitter circuitry and the receiver circuitry so that the communications device is operable to establish an RRC connection in a cell, to receive in the cell, in a first radio resource control (RRC) mode, the data associated with the service, the data transmitted using communication resources of a wireless access interface, to measure, in the first RRC mode, a radio link quality associated with the wireless access interface, to determine, based on the radio link quality, that predetermined criteria are satisfied, the predetermined criteria for continuing to receive the data associated with the service in the first RRC mode in the cell, and after determining that the predetermined criteria are satisfied, to receive further data associated with the service.

Paragraph 39. A communications device for operating in a wireless communications network, the communications device comprising a transmitter configured to transmit signals on a wireless access interface provided by an infrastructure equipment of the wireless communications network, a receiver configured to receive signals on the wireless access interface, the signals representing data associated with a service, the service being a multicast or broadcast service and a controller configured to control the transmitter and the receiver so that the communications device is operable to establish an RRC connection in a cell, to receive in the cell, in a first radio resource control (RRC) mode, the data associated with the service, the data transmitted using communication resources of a wireless access interface via a point to multipoint (PTM) bearer, to determine that second predetermined criteria are satisfied, and in response to determining that the second predetermined criteria are satisfied, to transmit a point to point (PTP) bearer request, the PTP bearer request requesting parameters for a PTP bearer for receiving the data associated with the service.

Paragraph 40. Circuitry for a communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, the signals representing data associated with a service, the service being a multicast or broadcast service and controller circuitry configured to control the transmitter circuitry and the receiver circuitry so that the communications device is operable to establish an RRC connection in a cell, to receive in the cell, in a first radio resource control (RRC) mode, the data associated with the service, the data transmitted using communication resources of a wireless access interface via a point to multipoint (PTM) bearer, to determine that second predetermined criteria are satisfied, and in response to determining that the second predetermined criteria are satisfied, to transmit a point to point (PTP) bearer request, the PTP bearer request requesting parameters for a PTP bearer for receiving the data associated with the service.

Paragraph 41. Infrastructure equipment for use in a wireless communications network, the infrastructure equipment providing a wireless access interface, the infrastructure equipment comprising a transmitter configured to transmit signals via the wireless access interface, the signals representing data associated with a service, the service being a multicast or broadcast service, a receiver configured to receive signals, and a controller configured to control the transmitter and the receiver so that the infrastructure equipment is operable to transmit to a communications device the data associated with the service, the communications device in a first RRC mode, and to receive a re-establishment request transmitted by the communications device, wherein when the re-establishment request is received, no data radio bearer was established for the communications device or no signalling radio bearer (SRB) for the transmission of encapsulated non-access stratum (NAS) messages was established for the communications device.

Paragraph 42. Circuitry for infrastructure equipment for use in a wireless communications network, the infrastructure equipment providing a wireless access interface, the circuitry comprising transmitter circuitry configured to transmit signals via the wireless access interface, the signals representing data associated with a service, the service being a multicast or broadcast service, receiver circuitry configured to receive signals, and controller circuitry configured to control the transmitter circuitry and the receiver circuitry so that the infrastructure equipment is operable to transmit to a communications device the data associated with the service, the communications device in a first RRC mode, and to receive a re-establishment request transmitted by the communications device, wherein when the re-establishment request is received, no data radio bearer was established for the communications device or no signalling radio bearer (SRB) for the transmission of encapsulated non-access stratum (NAS) messages was established for the communications device.

Paragraph 43. Infrastructure equipment for use in a wireless communications network, the infrastructure equipment providing a wireless access interface, the infrastructure equipment comprising a transmitter configured to transmit signals via the wireless access interface, the signals representing data associated with a service, the service being a multicast or broadcast service, a receiver configured to receive signals, and a controller configured to control the transmitter and the receiver so that the infrastructure equipment is operable to establish an RRC connection with a communications device in a cell, to transmit in the cell the data associated with the service, the data transmitted using communication resources of the wireless access interface via a point to multipoint (PTM) bearer, and to receive a point to point (PTP) bearer request transmitted by the communications device, the PTP bearer request requesting parameters for a PTP bearer for receiving the data associated with the service.

Paragraph 44. Circuitry for infrastructure equipment for use in a wireless communications network, the infrastructure equipment providing a wireless access interface, the circuitry comprising transmitter circuitry configured to transmit signals via the wireless access interface, the signals representing data associated with a service, the service being a multicast or broadcast service, receiver circuitry configured to receive signals, and controller circuitry configured to control the transmitter and the receiver so that the infrastructure equipment is operable to establish an RRC connection with a communications device in a cell, to transmit in the cell the data associated with the service, the data transmitted using communication resources of the wireless access interface via a point to multipoint (PTM) bearer, and to receive a point to point (PTP) bearer request transmitted by the communications device, the PTP bearer request requesting parameters for a PTP bearer for receiving the data associated with the service.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] 3GPP TS 38.300 v. 15.2.0 “NR; NR and NG-RAN Overall Description; Stage 2(Release 15)”, June 2018
[2] Holma H. and Toskala A, “LTE for UMTS OFDMA and SC-FDMA based radio access”, John Wiley and Sons, 2009
[3] 3GPP TS 38.331 “NR; Radio Resource Control (RRC); Protocol specification”, version 16.1.0, July 2020
[4] 3GPP Tdoc R2-2006794 “NR Multicast dynamic PTM PTP switch with service continuity”, 3GPP TSG-RAN WG2 Meeting #111e, August 2020, Qualcomm Inc.
[5] 3GPP Tdoc R2-2007631 “Protocol structure and bearer modelling for NR MBS”, 3GPP TSG-RAN WG2 Meeting #111e, August 2020, Ericsson

1. A method of receiving data associated with a service at a communications device, the service being a multicast or broadcast service, the method comprising
establishing an RRC connection in a cell,
receiving in the cell, in a first radio resource control (RRC) mode, the data associated with the service, the data transmitted using communication resources of a wireless access interface,
measuring, in the first RRC mode, a radio link quality associated with the wireless access interface,
determining, based on the radio link quality, that predetermined criteria are satisfied, the predetermined criteria for continuing to receive the data associated with the service in the first RRC mode in the cell, and
after determining that the predetermined criteria are satisfied, receiving further data associated with the service.

2. A method according to claim 1, the method comprising
transmitting, in response to determining that the predetermined criteria are satisfied, a re-establishment request message.

3. A method according to claim 1, wherein no data radio bearer (DRB) was established for the communications device when the predetermined criteria are satisfied.

4. A method according to claim 1, wherein no signalling radio bearer (SRB) for the transmission of encapsulated non-access stratum (NAS) messages was established for the communications device when the criteria for the radio link failure were satisfied.

5. A method according to claim 4, wherein the signalling radio bearer is a signalling bearer exclusively for the transmission of uplink or downlink information messages which encapsulate NAS messages.

6. A method according to claim 2, the method comprising
receiving a re-establishment response message, the re-establishment response message transmitted in response to the re-establishment request message and
entering the first RRC mode.

7. A method according to claim 6, wherein the re-establishment response message comprises an indication of parameters associated with a new radio bearer,
and wherein receiving the further data associated with the service comprises receiving the data via the new radio bearer.

8. A method according to claim 7, wherein the new radio bearer is a point-to-multipoint bearer.

9. A method according to claim 1, wherein receiving the further data associated with the service comprises receiving the data associated with the service when in the first RRC mode.

10. A method according to claim 1, the method comprising
in response to determining that the predetermined criteria are satisfied, entering a second RRC mode, wherein
receiving the further data associated with the service comprises receiving the further data associated with the service when in the second RRC mode.

11. A method according to claim 10, wherein the second RRC mode is an RRC idle mode.

12. A method according to claim 10, wherein the second RRC mode is an RRC inactive mode, the method comprising
receiving, in the first RRC mode, an inactive mode configuration.

13. A method according to claim 10, the method comprising:
in response to determining that the predetermined criteria are satisfied, determining whether an inactive mode configuration was received in the first RRC mode, wherein
entering the second RRC mode is in response to the determining whether an inactive mode configuration was received in the first RRC mode.

14. A method according to claim 1, the method comprising
in response to determining that the predetermined criteria are satisfied, performing a cell selection.

15. A method according to claim 1, the method comprising
in response to determining that the predetermined criteria are satisfied, determining that a radio link failure has occurred.

16. A method according to claim 1, the method comprising
receiving an indication of one or more of the predetermined criteria.

17. (canceled)

18. A method according to claim 1, wherein the predetermined criteria are implementation-specific criteria.

19. A method according to claim 1, wherein in the first RRC mode, the communications device is configured with a single bandwidth part, the single bandwidth part for receiving the MBS data.

20-38. (canceled)

39. A communications device for operating in a wireless communications network, the communications device comprising
a transmitter configured to transmit signals on a wireless access interface provided by an infrastructure equipment of the wireless communications network,
a receiver configured to receive signals on the wireless access interface, the signals representing data associated with a service, the service being a multicast or broadcast service and
a controller configured to control the transmitter and the receiver so that the communications device is operable
to establish an RRC connection in a cell,
to receive in the cell, in a first radio resource control (RRC) mode, the data associated with the service, the data transmitted using communication resources of a wireless access interface via a point to multipoint (PTM) bearer,
to determine that second predetermined criteria are satisfied, and
in response to determining that the second predetermined criteria are satisfied, to transmit a point to point (PTP) bearer request, the PTP bearer request requesting parameters for a PTP bearer for receiving the data associated with the service.

40. (canceled)

41. Infrastructure equipment for use in a wireless communications network, the infrastructure equipment providing a wireless access interface, the infrastructure equipment comprising
a transmitter configured to transmit signals via the wireless access interface, the signals representing data associated with a service, the service being a multicast or broadcast service,
a receiver configured to receive signals, and
a controller configured to control the transmitter and the receiver so that the infrastructure equipment is operable
to transmit to a communications device the data associated with the service, the communications device in a first RRC mode, and
to receive a re-establishment request transmitted by the communications device, wherein when the re-establishment request is received, no data radio bearer was established for the communications device or no signalling radio bearer (SRB) for the transmission of encapsulated non-access stratum (NAS) messages was established for the communications device.

42.-44. (canceled)
